(19) United States
(12) Patent Application Publication
(10) Pub. No.: US 2026/0301384 A1
(43) Pub. Date: Oct. 1, 2026

(54) IMAGE PROCESSING APPARATUS AND AUTONOMOUS MOVING BODY

(71) Applicant: Honda Motor Co., Ltd., Tokyo (JP)

(72) Inventors: Umiaki Matsubara, Saitama (JP); Tokitomo Ariyoshi, Saitama (JP); Mayu Watanabe, Saitama (JP); Yutaka Nishizaki, Tokyo (JP); Meika Sugimoto, Tokyo (JP); Taisei Ito, Tokyo (JP); Miki Kawabuchi, Tokyo (JP); Ryosuke Kasuga, Tokyo (JP)

(21) Appl. No.: 19/631,021

(22) Filed: Mar. 27, 2026

(30) Foreign Application Priority Data
Mar. 31, 2025 (JP) 2025-057740

(51) Int. Cl. G06V 10/774; G06T 11/65; G06T 15/00; G06V 20/58; G06V 20/56

(52) U.S. Cl. CPC G06V 10/774; G06T 11/65; G06T 15/00; G06V 20/58; G06V 20/588

(57) ABSTRACT

An image processing apparatus for processing two-dimensional or three-dimensional images, includes: a microprocessor and a memory connected to the microprocessor. The memory stores first image data obtained by imaging and condition information indicating an imaging condition of the first image data as learning data, and the microprocessor is configured to perform: applying predetermined image processing to second image data obtained by imaging and generating third image data to be output to a recognition model constructed by machine learning using the learning data. The microprocessor is configured to perform: the generating including applying the predetermined image processing to the second image data to generate the third image data corresponding to the imaging condition of the first image data.

### CROSS-REFERENCE TO RELATED APPLICATION

This application is based upon and claims the benefit of priority from Japanese Patent Application No. 2025-057740 filed on March 31, 2025, the content of which is incorporated herein by reference.

### BACKGROUND

### TECHNICAL FIELD

The present invention relates to an image processing apparatus and an autonomous moving body for processing image data.

### Related Art

Conventionally, there is known a device that inputs a photographed image of an in-vehicle camera to a neural network and performs object recognition by estimation processing of the neural network (see e.g., JP 2021-114048 A). In the device described in JP 2021-114048 A, in order to obtain a robust recognition result, learning data that is difficult to collect in an actual image is supplemented with a computer graphics (CG) image.

However, in order to obtain a robust recognition result, it is necessary to prepare a CG image reflecting a wide variety of situations observed in the actual environment, and a great effort and a high performance computing environment are required.

### SUMMARY

An aspect of the present invention is an image processing apparatus for processing two-dimensional or three-dimensional images, including: a microprocessor and a memory connected to the microprocessor. The memory stores first image data obtained by imaging and condition information indicating an imaging condition of the first image data as learning data, and the microprocessor is configured to perform: applying predetermined image processing to second image data obtained by imaging and generating third image data to be output to a recognition model constructed by machine learning using the learning data. The microprocessor is configured to perform: the generating including applying the predetermined image processing to the second image data to generate the third image data corresponding to the imaging condition of the first image data.

Another aspect of the present invention is an autonomous moving body equipped with an image processing apparatus for processing two-dimensional or three-dimensional images, including: an actuator for movement; a microprocessor and a memory connected to the microprocessor. The memory stores first image data obtained by imaging and condition information indicating an imaging condition of the first image data as learning data, and the microprocessor is configured to perform: applying predetermined image processing to second image data obtained by imaging and generating third image data to be output to a recognition model constructed by machine learning using the learning data, the recognition model being a learning model recognizing an object in an image indicated by the image data based on input image data, and controlling the actuator based on a recognition result of the recognition model with the third image data as input. The microprocessor is configured to perform: the generation including applying the predetermined image processing to the second image data to generate the third image data corresponding to the imaging condition of the first image data.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of an image processing system according to an embodiment of the present invention;

FIG. 2 is a block diagram illustrating a main configuration of a travel control apparatus mounted on a vehicle;

FIG. 3A is a diagram illustrating an example of a captured image;

FIG. 3B is a diagram illustrating another example of a captured image;

FIG. 3C is a diagram illustrating another example of a captured image;

FIG. 4 is a diagram illustrating another example of a captured image; and

FIG. 5 is a flowchart illustrating an example of processing executed by the controller of FIG. 2.

### DETAILED DESCRIPTION

Hereinafter, embodiments of the invention will be described with reference to the drawings. An image processing system (hereinafter also referred to as an image processing device) according to an embodiment of the present invention is a device for generating learning data of an image recognition model used for traveling of a vehicle. Note that a vehicle to which the image processing system according to the present embodiment is applied may be referred to as a host vehicle to be distinguished from other vehicles.

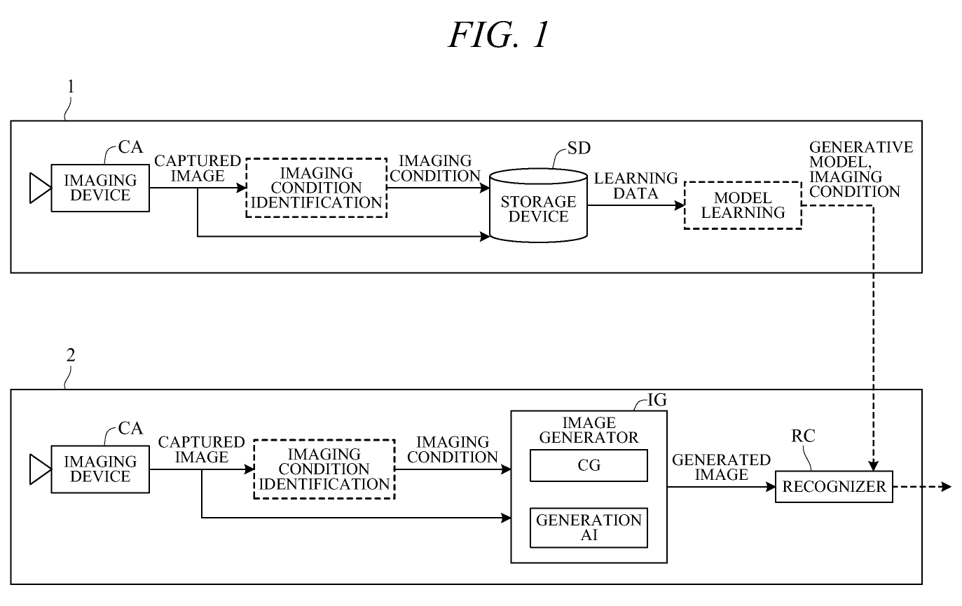

FIG. 1 is a block diagram schematically illustrating an overall configuration of image processing system 100 according to the present embodiment. As illustrated in FIG. 1, the image processing system 100 includes a learning processing device 1 and an image generation device 2. The learning processing device 1 and the image generation device 2 are communicably connected via a communication network such as a Controller Area Network (CAN).

Note that the learning processing device 1 and the image generation device 2 may be configured by a single device. In addition, the image processing system 100 may include the learning processing device 1 mounted on another vehicle. That is, the image processing system 100 may include a plurality of learning processing devices 1. Furthermore, the image processing system 100 may include the learning processing device 1 configured by an external server device or the like.

The learning processing device 1 includes an imaging device CA. In a case where the learning processing device 1 is mounted on the host vehicle, the imaging device CA is an in-vehicle camera. The learning processing device 1 stores the captured image data (hereinafter also simply referred to as captured image) acquired by the imaging device CA in the storage device SD. The captured image stored in the storage device SD is used as learning data of model learning (machine learning).

Furthermore, the learning processing device 1 acquires reference information that is information regarding the host vehicle and the external environment of the host vehicle, and identifies an imaging condition when the captured image of the imaging device CA is acquired based on the reference information. The learning processing device 1 stores information indicating the identified imaging condition (hereinafter referred to as condition information) in the storage device SD.

The reference information includes map data including a road on which the host vehicle travels, host vehicle information, and external information. The map data may be configured as two-dimensional or three-dimensional data. The host vehicle information is information regarding the host vehicle, and includes position information indicating a position of the host vehicle (host vehicle position) and the like. The external information is information regarding the external environment of the host vehicle, and includes weather information and the like.

The learning processing device 1 constructs a recognition model by machine learning using the captured image and the condition information stored in the storage device SD as learning data. The recognition model is a learning model that recognizes an object in an image indicated by input image data based on the image data. The learning processing device 1 outputs the recognition model and the condition information used to construct the recognition model to a recognizer RC.

The recognizer RC stores the recognition model in association with the imaging condition indicated by the condition information used to construct the recognition model. That is, the recognizer RC stores a recognition model for each imaging condition. In addition, the recognizer RC stores information (hereinafter referred to as model correspondence information) indicating a correspondence between an imaging condition and a recognition model.

When a captured image is acquired by the imaging device CA, the image generation device 2 identifies an imaging condition of the captured image. The image generation device 2 inputs the captured image of the imaging device CA to the image generator IG together with the identified imaging condition.

When the recognition model (hereinafter referred to as a correspondence recognition model) corresponding to the identified imaging condition is not stored in the recognizer RC, the image generator IG applies the reverse rendering processing to the captured image of the imaging device CA. The reverse rendering processing is processing of applying at least one of CG processing and image processing by image generation Artificial Intelligence (AI) to an input image to generate a captured image under a specific imaging condition. The image generator IG applies the reverse rendering processing to the captured image of the imaging device CA to generate a captured image under an imaging condition suitable for the recognition model stored in the recognizer RC.

The image generator IG outputs the image (hereinafter referred to as a generated image) generated by the reverse rendering processing to the recognizer RC. Note that, in a case where the correspondence recognition model is stored in the recognizer RC, the reverse rendering processing is not executed, and the captured image of the imaging device CA is directly input to the recognizer RC. The recognizer RC recognizes an object in the generated image using the recognition model and outputs a recognition result. The recognition result output from the recognizer RC is used for travel control of the host vehicle.

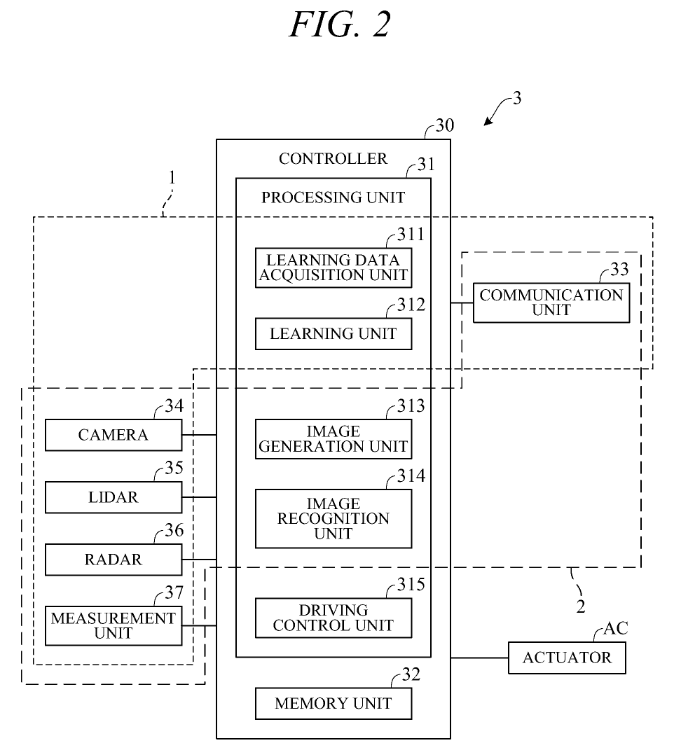

FIG. 2 is a block diagram illustrating a configuration of a main part of the host vehicle, more specifically, a configuration of a main part of a travel control device mounted on the host vehicle. As illustrated in FIG. 2, the travel control device 3 includes the image processing system 100 (the learning processing device 1 and the image generation device 2) in FIG. 1. The travel control device 3 includes a controller 30, a communication unit 33, a camera 34, a LiDAR 35, a radar 36, a measurement unit 37, and an actuator AC.

The communication unit 33 is a communication interface that connects the travel control device 3 to the CAN or another communication network. The other communication network includes not only a public wireless communication network represented by the Internet network, a mobile telephone network, or the like but also a closed communication network provided for every predetermined management region, for example, a wireless LAN, Wi-Fi (registered trademark), Bluetooth (registered trademark), or the like. The travel control device 3 transmits and receives information to and from an external device via the communication unit 33.

The camera 34 may be a monocular camera or a stereo camera, and images the surroundings of the host vehicle. The camera 34 is attached to, for example, a predetermined position in the front part of the host vehicle, and continuously images the space in front of the host vehicle at a predetermined frame rate and outputs image data serving as detection information to the controller 30. The camera 34 corresponds to the imaging device CA in FIG. 1.

The radar 36 is mounted on the host vehicle and detects other vehicles, obstacles, and the like around the host vehicle by emitting electromagnetic waves and detecting reflected waves. The radar 36 outputs detection values (detection data) serving as detection information to the controller 30. The LiDAR 35 is mounted on the host vehicle, and measures scattered light with respect to irradiation light in all directions of the host vehicle and detects a distance from the host vehicle to an obstacle in the surroundings. The LiDAR 35 outputs detection values (detection data) serving as detection information to the controller 30.

The measurement unit 37 includes a positioning sensor that receives a signal for positioning transmitted from a positioning satellite, and measures a current position (latitude, longitude, and altitude) of the host vehicle by using positioning information received by the positioning sensor. The positioning satellite is an artificial satellite such as a GPS satellite or a quasi-zenith satellite. In addition, the measurement unit 37 includes a magnetic sensor (electronic compass) and measures the orientation of the host vehicle. Note that the measurement unit 37 may estimate the orientation of the host vehicle based on the transition of the host vehicle position.

The actuator AC is a traveling actuator for controlling traveling of the host vehicle. In a case where the traveling drive source is an engine, the actuator AC includes a throttle actuator that adjusts an opening degree (a throttle opening degree) of a throttle valve of the engine. In a case where the traveling drive source is a travel motor, the actuator AC includes the travel motor. The actuator AC also includes a brake actuator that actuates a braking device of the host vehicle and a steering actuator that drives a steering device.

The controller 30 is configured to include a computer including a processing unit 31 such as a CPU (microprocessor), a memory unit 32 such as a ROM and a RAM, and other peripheral circuits (not illustrated) such as an I/O interface. The memory unit 32 corresponds to the storage device SD in FIG. 1. The memory unit 32 stores map data including a road map. The processing unit 31 functions as a learning data acquisition unit 311, a learning unit 312, an image generation unit 313, an image recognition unit 314, and a driving control unit 315 by executing a program stored in the memory unit 32.

The communication unit 33, the camera 34, the LiDAR 35, the radar 36, the measurement unit 37, the learning data acquisition unit 311, and the learning unit 312 are included in the learning processing device 1. The communication unit 33, the camera 34, the LiDAR 35, the radar 36, the measurement unit 37, the image generation unit 313, the image recognition unit 314, and the driving control unit 315 are included in the image generation device 2. The image generation unit 313 functions as the image generator IG in FIG. 1. The image recognition unit 314 functions as the recognizer RC in FIG. 1 together with the memory unit 32.

The learning data acquisition unit 311 stores the captured image acquired by the camera 34 in the memory unit 32. The captured image acquired by the learning data acquisition unit 311 is referred to as an image at the time of learning. The image at the time of learning stored in the memory unit 32 is used as learning data by the learning unit 312.

In addition, the learning data acquisition unit 311 acquires reference information. Specifically, the learning data acquisition unit 311 acquires map data stored in the memory unit 32. Note that the learning data acquisition unit 311 may acquire the map information from a map providing server (not illustrated). The learning data acquisition unit 311 recognizes (acquires) the position and orientation of the host vehicle on the map based on the acquired map data and the information obtained by the measurement unit 37. Furthermore, the learning data acquisition unit 311 acquires external information from an external server device or the like via the communication unit 13.

The external information includes information regarding weather, a light environment, a surrounding object, a road surface state, a shadow, a traffic condition, and the like. The learning data acquisition unit 311 acquires information regarding the weather from an external weather information providing server (not illustrated) via the communication unit 13. The information regarding the weather includes information indicating a type of weather (e.g., sunny, cloudy, and snowy), presence or absence of rainfall, a type of rain (drizzle, heavy rain, etc.), presence or absence of wind, a type of wind (e.g., storm, turbulence), and the like.

The information indicating the light environment includes information (hereinafter referred to as astronomical information.) that can identify the position of the celestial body and the like. The learning data acquisition unit 311 estimates (calculates) a positional relationship between the host vehicle and the celestial body at that time point based on the position or orientation of the host vehicle and the astronomical information. The learning data acquisition unit 311 calculates an incident angle and characteristics (e.g., light amount and illuminance) of light from a specific celestial body (e.g., the sun, the moon) serving as a light source based on the estimated positional relationship. Note that the learning data acquisition unit 311 may calculate the incident angle and characteristics of light from the celestial body based on the image at the time of learning or using a sensor (not illustrated) such as an illuminance sensor. Furthermore, the information indicating the light environment may include information that can identify a position of a light source other than the celestial body, for example, a lighting device, a street lamp, or the like.

The information regarding the surrounding objects includes information indicating characteristics (hereinafter referred to as surface characteristics) of a surface of a structure (e.g., a building, a road sign) and a natural object (e.g., plantation) around the host vehicle. The surface characteristics are a surface material and a surface texture, and are characteristics that affect the outer appearance of a structure or a natural object, such as gloss, reflection, and irregularities. The learning data acquisition unit 311 recognizes the surface characteristics of the surrounding object based on the image at the time of learning. In a case where the information on the surface characteristics is included in the map data, the learning data acquisition unit 311 may recognize the surface characteristics of the surrounding object based on the map data.

The information regarding the road surface includes information indicating a road surface state. The road surface state includes a dry state, a frozen state, a snow accumulated state, and the like. The learning data acquisition unit 311 recognizes the road surface state based on the image at the time of learning. Note that the learning data acquisition unit 311 may estimate the road surface state based on information regarding the weather, a slip rate of the host vehicle, or the like.

The information regarding the shadow is information indicating whether or not a shadow (projected shadow or self-shadow) is formed by a light source on a road surface, a traffic participant, an object, or the like. The learning data acquisition unit 311 recognizes a shadow formed on a road surface or the like based on the image at the time of learning. Note that the learning data acquisition unit 311 may estimate the position and shape of the shadow formed on the road surface or the like based on the positional relationship between the host vehicle and the light source.

The information regarding the traffic condition includes traffic information indicating a traffic condition (such as a traffic jam) of the road. The learning data acquisition unit 311 acquires traffic information of a road on which the host vehicle is traveling from an external traffic information distribution server (not illustrated) via the communication unit 13.

Based on the acquired reference information, the learning data acquisition unit 311 identifies an imaging condition of the image at the time of learning, more specifically, an imaging condition indicating the weather, the light environment, the surface characteristics of the surrounding object, the road surface state, the shadow, the traffic condition, and the like at the time point when the image at the time of learning is acquired by the camera 34. Note that the image at the time of learning itself may be used to identify the imaging condition. Specifically, the learning data acquisition unit 311 may analyze the image at the time of learning and identify the imaging condition of the image at the time of learning based on the analysis result.

The learning data acquisition unit 311 stores the condition information indicating the identified imaging condition in the memory unit 32 in association with the image at the time of learning. The condition information stored in the memory unit 32 is used as learning data by the learning unit 312.

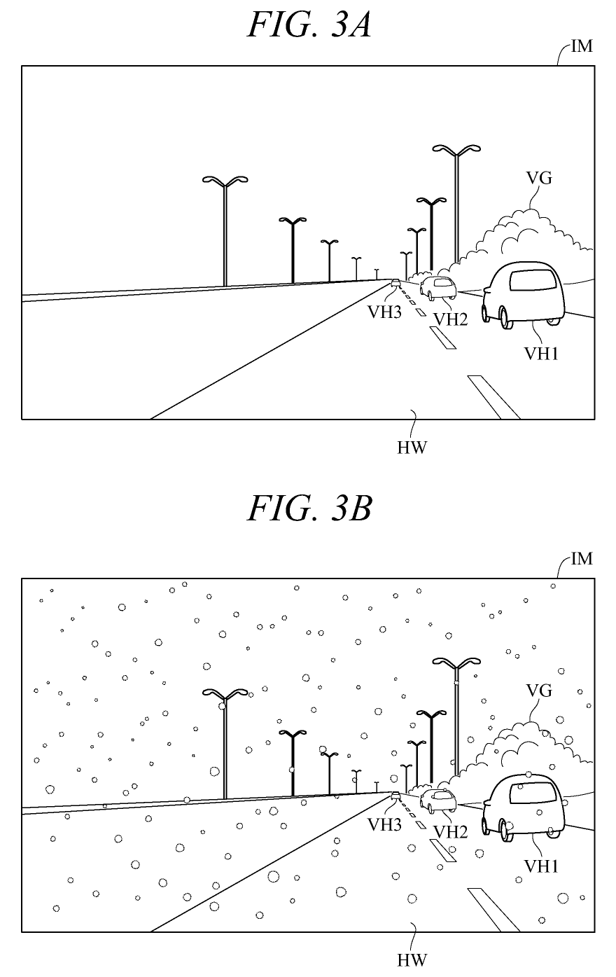

FIGS. 3A to 3C are diagrams illustrating examples of captured images acquired at the date and time T1 by the in-vehicle camera (camera 34) of the host vehicle traveling on the highway HW. The vehicles VH1 to VH3 are front vehicles having the same advancing direction as the host vehicle. FIG. 3A illustrates a captured image in a case where the weather at the date and time T1 was fine weather. FIG. 3B illustrates a captured image in a case where the weather at the date and time T1 was snowfall. FIG. 3C illustrates a captured image in a case where the weather at the date and time T1 was fine weather and a backlight condition in which the sun SU is in front of the host vehicle was obtained.

When the image at the time of learning is the captured image in FIG. 3A, the learning data acquisition unit 311 stores the condition information indicating that the weather is sunny in the memory unit 32. Furthermore, when the image at the time of learning is the captured image in FIG. 3B, the learning data acquisition unit 311 stores the condition information indicating that the weather is snowy in the memory unit 32. Furthermore, when the image at the time of learning is the captured image in FIG. 3C, the learning data acquisition unit 311 stores, in the memory unit 32, the condition information indicating that the light environment is backlight and that a shadow is formed on the road surface on the rear side (near side in the figure) of the front vehicles VH1 to VH3 and the plantation VG.

The learning unit 312 constructs a recognition model by machine learning using the learning data (the image at the time of learning and the condition information) stored in the memory unit 32. The learning unit 312 stores the constructed recognition model and the condition information used to construct the recognition model in the memory unit 32. Furthermore, the learning unit 312 stores model correspondence information indicating a correspondence between the recognition model and the imaging condition indicated by the condition information in the memory unit 32. At this time, in a case where a recognition model associated with the same imaging condition as the imaging condition indicated by the condition information is already stored in the memory unit 32, the learning unit 312 updates the recognition model with the constructed recognition model.

When a captured image (hereinafter referred to as a current image) is acquired by the camera 34 while the host vehicle is traveling, the image generation unit 313 acquires reference information. Based on the acquired reference information, the image generation unit 313 identifies an imaging condition of the current image, more specifically, an imaging condition (hereinafter referred to as an imaging condition at the time of recognition) indicating the weather, the light environment, the surface characteristics of the surrounding object, the road surface state, the shadow, the traffic condition, and the like at the time point when the current image is acquired by the camera 34. Note that the reference information acquisition method and the imaging condition specification method are similar to those of the learning data acquisition unit 311.

The image generation unit 313 refers to the model correspondence information and determines whether or not the correspondence recognition model, specifically, the recognition model corresponding to the imaging condition at the time of recognition is stored in the memory unit 32. When it is determined that the correspondence recognition model is stored in the memory unit 32, the image recognition unit 314 recognizes an object in the current image using the correspondence recognition model. Specifically, the image recognition unit 314 inputs the current image to the correspondence recognition model and acquires the recognition result of the object output from the correspondence recognition model.

On the other hand, when it is determined that the correspondence recognition model is not stored in the memory unit 32, the image generation unit 313 applies the reverse rendering processing to the current image, and generates an image under the imaging conditions suitable for the recognition model (hereinafter referred to as a non-correspondence recognition model) stored in the memory unit 32. Note that, in a case where a plurality of non-correspondence recognition models are stored in the memory unit 32, the image generation unit 313 selects any of the non-correspondence recognition models and generates an image under an imaging condition suitable for the non-correspondence recognition model.

For example, when the content of a predetermined item (e.g., weather) of the imaging condition supported by the non-correspondence recognition model matches the imaging condition at the time of recognition, the image generation unit 313 may preferentially select the non-correspondence recognition model. Furthermore, for example, the image generation unit 313 may calculate the similarity between the imaging condition supported by the non-correspondence recognition model and the imaging condition at the time of recognition, and preferentially select a non-correspondence recognition model having a high similarity. The similarity may be determined based on the number of items having the same content among the items (weather, light environment, surrounding object, road surface state, shadow, and traffic condition) of the imaging condition, or may be determined based on other criteria.

Here, the reverse rendering processing will be described. The image generation unit 313 applies the CG processing to the current image so that the imaging conditions (weather, light environment, surface characteristics of the surrounding object, road surface state, shadow, traffic condition, etc.) of the current image match the imaging conditions supported by the non-correspondence recognition model.

Note that compared to the actual captured image (hereinafter referred to as actual image), the image to which the CG processing is applied differs from the actual image in gradation characteristics. More specifically, the image to which the CG processing is applied generally has a larger change in an edge portion of luminance and RGB values than the actual image, and has less noise and shade change in a region that is not the edge portion. Therefore, in a case where the current image after the CG processing is input to the non-correspondence recognition model, there is a possibility that a desired recognition result cannot be obtained from the non-correspondence recognition model.

Therefore, the image generation unit 313 converts the gradation characteristics of the current image after the CG processing so as to reduce the difference in gradation characteristics between the current image after the CG processing and the actual image. Specifically, the image generation unit 313 applies the characteristic conversion processing with respect to the current image after the CG processing. More specifically, the image generation unit 313 converts the characteristics of the current image after the CG processing so as to reduce the change in the edge portion and to increase the noise and the shade change in the region that is not the edge portion.

Note that the image generation unit 313 may apply reverse rendering processing by image generation Artificial Intelligence (AI) to the current image, instead of the reverse rendering processing by the CG processing. More specifically, the image generation unit 313 may apply the reverse rendering processing to the current image by using the image generation AI capable of generating image data corresponding to the input imaging condition.

In the reverse rendering processing by the image generation AI, the image generation unit 313 inputs the current image and an instruction sentence (text) indicating an imaging condition supported by the non-correspondence recognition model to the image generation AI. As a result, the current image to which the reverse rendering processing has been applied is output from the image generation AI.

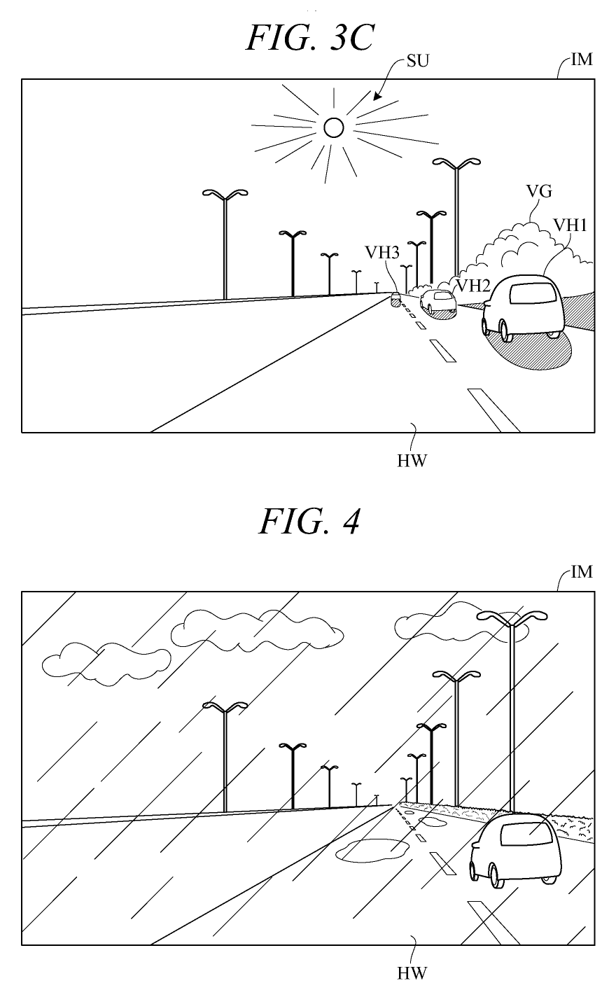

FIG. 4 is a diagram illustrating an example of a captured image acquired at date and time T2 by the in-vehicle camera (camera 34) of the host vehicle during traveling. FIG. 4 illustrates a captured image acquired at the time of rainfall. For example, in a case where the current image is the captured image in FIG. 4, and when only the recognition model corresponding to fine weather is stored in the memory unit 32, that is, when the recognition model corresponding to rainfall is not stored, the image generation unit 313 applies the reverse rendering processing to the current image. Specifically, the image generation unit 313 applies reverse rendering processing for converting the imaging conditions of the current image from rainfall to fine weather.

In a case where the reverse rendering processing by the image generation AI is applied to the captured image in FIG. 4, the image generation unit 313 inputs, to the image generation AI, an instructions sentence "Please change this image from "rainy day" to "sunny day". Please remove clouds appearing in the sky and falling rain, and also remove wet portions and puddles in the ground. Please set the sky to a blue sky and adjust the brightness so as to have a sunny atmosphere during the day".

The image recognition unit 314 recognizes an object in the current image using the non-correspondence recognition model. Specifically, the image recognition unit 314 inputs the current image to which the reverse rendering processing has been applied to the non-correspondence recognition model, and acquires the recognition result of the object output from the non-correspondence recognition model.

The driving control unit 315 controls the actuator AC based on the recognition result of the object acquired by the image recognition unit 314. More specifically, the driving control unit 315 controls the actuator AC so that the host vehicle travels along the lane boundary line recognized by the image recognition unit 314. In addition, the driving control unit 315 controls the actuator AC so as to avoid collision or contact between the host vehicle and the traffic participant or the object on the road recognized by the image recognition unit 314.

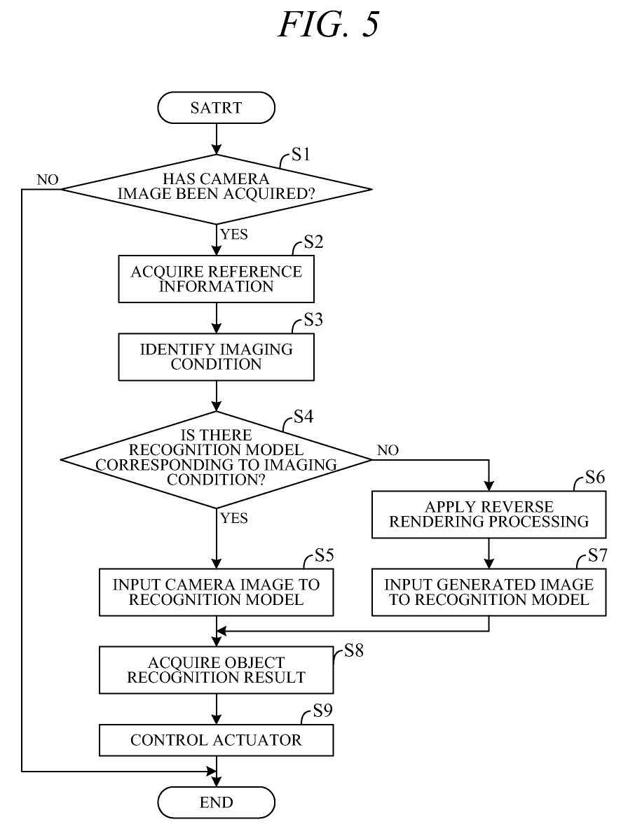

FIG. 5 is a flowchart illustrating an example of processing executed by the controller 30 of the travel control device 3 according to a predetermined program. The processing illustrated in the flowchart is started when the controller 30 is activated, and is repeated at a predetermined cycle.

First, in step S1, the controller 30 determines whether or not a captured image (hereinafter referred to as a camera image) has been acquired by the camera 34. When a negative determination is made in step S1, the controller 30 ends the processing.

When an affirmative determination is made in step S1, the controller 30 acquires reference information in step S2. In step S3, the controller 30 identifies an imaging condition of the camera image based on the reference information acquired in step S2. In step S4, the controller 30 determines whether or not the recognition model corresponding to the imaging condition identified in step S3 is stored in the memory unit 32.

When an affirmative determination is made in step S4, the controller 30 inputs the camera image to the recognition model in step S5. When a negative determination is made in step S4, the controller 30 applies the reverse rendering processing to the camera image in step S6. In step S7, the controller 30 inputs the image generated by the reverse rendering processing, that is, the camera image to which the reverse rendering processing has been applied, to the recognition model.

In step S8, the controller 30 acquires the object recognition result output from the recognition model. In step S9, the controller 30 controls the actuator AC based on the object recognition result acquired in step S8.

According to the above-described embodiment, the following effects can be achieved.
(1) An image processing system 100 includes a storage device SD (memory unit 32) that stores first image data (image at the time of learning) obtained by imaging and condition information indicating an imaging condition of the image at the time of learning as learning data, a recognizer RC (image recognition unit 314 and memory unit 32) having a recognition model constructed by machine learning using the learning data, and an image generator IG (image generation unit 313) serving as an image generator that generates third image data to be output to the recognizer RC by applying predetermined image processing to second image data (current image) obtained by imaging (FIGS. 1 and 2). The image generator IG applies predetermined image processing (reverse rendering processing) to the second image data to generate third image data corresponding to the imaging condition of the first image data. As a result, the image recognition accuracy in the image processing device learned with limited learning data can be improved. As a result, it is possible to realize highly robust image recognition with a simple configuration.
(2) The image generator IG applies rendering processing corresponding to an imaging condition of the first image data to the second image data to generate third image data serving as a CG image. As a result, the input image can be brought close to the image under the condition learned by the recognizer. As a result, the image recognition accuracy is improved.
(3) The image generator IG inputs the second image data and the text indicating the imaging condition of the first image data to the image generation AI capable of generating image data corresponding to the input imaging condition, and acquires the image data output from the image generation AI as third image data. As a result, the input image can be brought close to the image under the condition learned by the recognizer. As a result, the image recognition accuracy is improved.
(4) The image generator IG further recognizes an imaging condition of the second image data. The image generator IG generates the third image data based on the imaging condition of the first image data and the imaging condition of the second image data. In this manner, an image can be generated more precisely by generating an image in consideration of the imaging condition at the time of input.
(5) The image processing system 100 further includes a communication unit 13 and a learning data acquisition unit 311 serving as an information acquisition unit that acquires information from the outside via the communication unit 13 (FIG. 2). The learning data acquisition unit 311 collects information related to the imaging condition of the first image data, generates condition information based on the collected information, and stores the condition information in the storage device SD (memory unit 32). As a result, the imaging condition can be acquired using the external information.
(6) The information related to the imaging condition of the first image data includes any one of weather information, astronomical information, map information, and traffic information. As a result, the input image can be brought close to the image under the condition learned by the recognizer. As a result, the image recognition accuracy is improved.
(7) The image processing system 100 further includes a measurement unit 37 serving as a measurement device that measures the position or orientation of the imaging device that acquires the second image data (FIG. 2). The learning data acquisition unit 311 estimates (calculates) a positional relationship between the imaging device and a specific celestial body based on the position or orientation of the host vehicle measured by the measurement unit 37 and the astronomical information, and generates condition information based on a calculation result. As a result, it is possible to estimate how light from a specific celestial body to be a light source, such as the sun or the moon, enters the host vehicle, and to generate an image more precisely.
(8) The storage device SD further stores map data. The image generator IG generates the third image data using the map data. As a result, the input image can be brought close to the image under the condition learned by the recognizer. As a result, the image recognition accuracy is improved.
(9) The map data includes any one of three-dimensional map data and data indicating a surface material or a surface texture of a structure. As a result, the input image can be brought close to the image under the condition learned by the recognizer. As a result, the image recognition accuracy is improved.
(10) A host vehicle serving as an autonomous mobile body is equipped with an image processing device that processes an image, and includes an actuator AC serving as a movement actuator, and a driving control unit 315 serving as a movement control unit. The image processing system 100 includes a storage device SD (memory unit 32) that stores first image data obtained by imaging and condition information indicating an imaging condition of the first image data as learning data, a recognizer RC (image recognition unit 314 and memory unit 32) having a recognition model constructed by machine learning using the learning data, and an image generator IG (image generation unit 313) that generates third image data to be output to the recognizer RC by applying predetermined image processing to the second image data obtained by imaging (FIGS. 1 and 2). The recognition model is a learning model that recognizes an object in an image indicated by the image data based on the input image data, and the image generator IG applies predetermined image processing to the second image data to generate third image data corresponding to an imaging condition of the first image data. The driving control unit 315 controls the actuator AC based on the recognition result of the recognition model having the third image data as an input. As described above, by mounting the image processing device learned with limited learning data on the autonomous moving body, the autonomous traveling of the autonomous moving body can be realized with a simple configuration.

The above embodiment can be modified into various forms. Hereinafter, modified examples will be described. In the above-described embodiment, the image processing system 100 in which the learning processing device 1 and the image generation device 2 process a two-dimensional camera image has been described as an example. However, the learning processing device 1 and the image generation device 2 may process three-dimensional image data, more specifically, an image (three-dimensional point cloud data) acquired by the LiDAR 35 or the radar 36.

Furthermore, in the above-described embodiment, the image generator IG (image generation unit 313) applies the reverse rendering processing to the current image to generate an image corresponding to the imaging condition of the image at the time of learning. However, the image generator may recognize, as the object recognition unit, the object in the current image before applying the reverse rendering processing to the current image. Then, the image generator may apply the reverse rendering processing to a region corresponding to the object in the current image. Furthermore, the image generator may apply the reverse rendering processing to a region corresponding to a specific object (vehicle, etc.) in the current image. As described above, the processing load can be reduced without lowering the recognition accuracy with respect to the specific object by applying the reverse rendering processing limiting to the region of the specific object.

Furthermore, in the above-described embodiment, a case where the image processing system 100 is applied to a vehicle serving as an autonomous moving body has been described as an example. However, the autonomous moving body may be other than a vehicle, and the image processing system may be applied to an automatic mower, a mobile robot, a drone flight vehicle, or the like.

The image processing device of the above-described embodiment can also be configured as an image processing method for processing a two-dimensional or three-dimensional image from another viewpoint. That is, the present invention can be configured as an image processing method including a first step of storing first image data obtained by imaging and condition information indicating an imaging condition of the first image data in a storage device as learning data, and a second step of applying predetermined image processing to second image data obtained by imaging to generate third image data to be output to a recognizer, in which the recognizer has a recognition model constructed by machine learning using the learning data described in the storage device, and in the second step, predetermined image processing is applied to the second image data to generate third image data corresponding to the imaging condition of the first image data.

Furthermore, the present invention can be configured by replacing the image processing method with a program for causing a computer to execute processing of processing a two-dimensional or three-dimensional image. Furthermore, the present invention can be configured by replacing the above program with a computer-readable storage medium in which such a program is recorded.

According to the present invention, highly robust image recognition can be realized with a simple configuration.

What is claimed is:

1. An image processing apparatus for processing two-dimensional or three-dimensional images, comprising:
a microprocessor and a memory connected to the microprocessor, wherein
the memory stores first image data obtained by imaging and condition information indicating an imaging condition of the first image data as learning data, and
the microprocessor is configured to perform:
applying predetermined image processing to second image data obtained by imaging and generating third image data to be output to a recognition model constructed by machine learning using the learning data, and wherein
the microprocessor is configured to perform:
the generating including applying the predetermined image processing to the second image data to generate the third image data corresponding to the imaging condition of the first image data.

2. The image processing apparatus according to claim 1, wherein
the microprocessor is configured to perform:
the generating including applying rendering processing corresponding to the imaging condition of the first image data to the second image data to generate the third image data as a CG (computer graphics) image.

3. The image processing apparatus according to claim 1, wherein
the microprocessor is configured to perform:
the generating including inputting the second image data and text indicating the imaging condition of the first image data to an image generation AI (Artificial Intelligence) capable of generating image data corresponding to an input imaging condition, and acquiring the image data output from the image generation AI as the third image data.

4. The image processing apparatus according to claim 2, wherein
the microprocessor is further configured to perform:
recognizing an object in an image indicated by the second image data, and
generating the third image data in which a region of the object in the image corresponds to the imaging condition of the first image data, based on the imaging condition of the first image data.

5. The image processing apparatus according to claim 2, wherein
the microprocessor is configured to perform:
the generating including further recognizing an imaging condition of the second image data, and generating the third image data based on the imaging condition of the first image data and the imaging condition of the second image data.

6. The image processing apparatus according to claim 1, further comprising:
a communication unit, wherein
the microprocessor is further configured to perform:
acquiring information from outside via the communication unit;
collecting the information related to the imaging condition of the first image data;
generating the condition information based on the information collected; and
storing the condition information in the memory.

7. The image processing apparatus according to claim 6, wherein
the information related to the imaging condition of the first image data includes any one of weather information, astronomical information, map information, and traffic information.

8. The image processing apparatus according to claim 7, further comprising:
a measurement device configured to measure a position or orientation of an imaging device acquiring the second image data, wherein
the microprocessor is configured to perform:
the acquiring including calculating a positional relationship between the imaging device and a specific celestial body based on the position or the orientation measured by the measurement device and the astronomical information, and generating the condition information based on a calculation result of the calculating.

9. The image processing apparatus according to claim 1, wherein
the memory further stores map data, and
the microprocessor is configured to perform:
the generating including generating the third image data using the map data.

10. The image processing apparatus according to claim 9, wherein
the map data includes any one of three-dimensional map data and data indicating surface material or surface texture of a structure.

11. An autonomous moving body equipped with an image processing apparatus for processing two-dimensional or three-dimensional images, comprising:
an actuator for movement;
a microprocessor and a memory connected to the microprocessor, wherein
the memory stores first image data obtained by imaging and condition information indicating an imaging condition of the first image data as learning data, and
the microprocessor is configured to perform:
applying predetermined image processing to second image data obtained by imaging and generating third image data to be output to a recognition model constructed by machine learning using the learning data, the recognition model being a learning model recognizing an object in an image indicated by the image data based on input image data, and
controlling the actuator based on a recognition result of the recognition model with the third image data as input, wherein
the microprocessor is configured to perform:
the generation including applying the predetermined image processing to the second image data to generate the third image data corresponding to the imaging condition of the first image data.
